(19) United States
(12) Patent Application Publication
(10) Pub. No.: US 2009/0290799 A1
(43) Pub. Date: Nov. 26, 2009

(54) Detection of Organ Area Corresponding to Facial Organ Image in Image

(75) Inventor: Kenji MATSUZAKA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/464,736

(22) Filed: May 12, 2009

(30) Foreign Application Priority Data
May 21, 2008 (JP) 2008-133424

(51) Int. Cl. G06K 9/46

(52) U.S. Cl. 382/195

(57) ABSTRACT

An image processing apparatus. A face area detecting unit detects a face area corresponding to a face image in a target image. An organ area detecting unit detects an organ area corresponding to a facial organ image in the face area. An organ detection omission ratio, which is a probability that the organ area detecting unit does not detect the facial organ image as the organ area, is smaller than a face detection omission ratio, which is a probability that the face area detecting unit does not detect the face image as the face area.

### CROSS REFERENCE TO RELATED APPLICATIONS

This application claims the benefit of priority under 35 USC 119 of Japanese patent application no. 2008-133424, filed on May 21, 2008, which is incorporated herein by reference.

### BACKGROUND

1. Technical Field

The present invention relates to detection of an image area corresponding to a facial organ image in an image.

2. Related Art

A technique is known for detecting an organ area, which is an image area corresponding to an image of a facial organ (such as eyes), in an image. See, for example, JP-A-2006-065640.

Upon detecting the organ area in the image, detection omissions in which a facial organ image contained in the image is not detected as an organ area are preferably prevented.

### SUMMARY

The invention provides an advantageous technique for preventing detection omission in which an organ area is not detected, upon detecting the organ area in an image.

An image processing apparatus according to an aspect of the invention includes: a face area detecting unit that detects a face area corresponding to a face image in a target image; and an organ area detecting unit that detects an organ area corresponding to a facial organ image in the face area. An organ detection omission ratio, which is a probability that the organ area detecting unit does not detect the facial organ image as the organ area, is smaller than a face detection omission ratio, which is a probability that the face area detecting unit does not detect the face image as the face area.

According to the image processing apparatus, the organ detection omission ratio in the organ area detecting unit is smaller than the face detection omission ratio in the face area detecting unit. Accordingly, detection omission can be prevented when the organ area is detected in an image.

In the image processing apparatus according to this aspect of the invention, the organ detection omission ratio may be a ratio of a number of organ sample images not detected as the organ area to a number of organ sample images, when an organ area detecting process is executed on a first sample image group having at least one organ sample image that contains the facial organ image and at least one non-organ sample image that does not contain the facial organ image. The face detection omission ratio may be a ratio of a number of face sample images not detected as the face area to a number of face sample images, when a face area detecting process is executed on a second sample image group having at least one face sample image containing the face image and at least one non-face sample image that does not contain the face image.

According to the image processing apparatus, detection omission can be prevented when an organ area is detected in an image.

In the image processing apparatus according to this aspect of the invention, the face area detecting unit may execute the face area detecting process by evaluating a certainty that an arbitrary image area in the target image corresponds to the face image, using face evaluation data generated by use of the second sample image group. In addition, the organ area detecting unit may execute the organ area detecting process by evaluating a certainty that an arbitrary image area in the face area corresponds to the facial organ image, using organ evaluation data generated by use of the first sample image group.

According to the image processing apparatus, the face area detecting unit executes the face area detecting process by evaluating the certainty that the arbitrary image area in the target image corresponds to the face image, using the face evaluation data generated by use of the second sample image group. In addition, the organ area detecting unit executes the organ area detecting process by evaluating the certainty that the arbitrary image area in the face area corresponds to the facial organ image, using the organ evaluation data generated by use of the first sample image group. Accordingly, detection omission can be prevented when the organ area is detected in an image.

In the image processing apparatus according to this aspect of the invention, the face evaluation data may be data generated by learning by use of the second sample image group. In addition, the organ evaluation data may be data generated by learning by use of the first sample image group and a learning condition different from that of the learning for generating the face evaluation data.

According to the image processing apparatus, the organ detection omission ratio in the organ area detecting unit can be set to be smaller than the face detection omission ratio in the face area detecting unit.

In the image processing apparatus according to this aspect of the invention, the face evaluation data may have a plurality of face identifiers connected in series and identifying whether the image area corresponds to the face image on the basis of an evaluation value representing the certainty that the image area corresponds to the face image. The organ evaluation data may have a plurality of organ identifiers connected in series and identifying whether the image area corresponds to the facial organ image on the basis of an evaluation value representing the certainty that the image area corresponds to the facial organ image. In addition, the number of organ identifiers may be smaller than the number of face identifiers.

According to the image processing apparatus, the organ detection omission ratio in the organ area detecting unit can be set to be smaller than the face detection omission ratio in the face area detecting unit.

In the image processing apparatus according to this aspect of the invention, an organ detection error ratio, which is a probability that the organ area detecting unit detects an image that is not the facial organ image as the organ area, may be larger than a face detection error ratio, which is a probability that the face area detecting unit detects an image that is not the face image as the face area.

In the image processing apparatus according to this aspect of the invention, the organ detection error ratio may be a ratio of the number of non-organ sample images detected as the organ area to the number of non-organ sample images, when the organ area detecting process is executed on the first sample image group having at least one organ sample image that contains the facial organ image and at least one non-organ sample image that does not contain the facial organ image. In addition, the face detection error ratio may be a ratio of the number of non-face sample images detected as the face area to the number of non-face sample images, when the face area detecting process is executed on the second sample image group having at least one face sample image containing the face image and at least one non-face sample image that does not contain the face image.

In the image processing apparatus according to this aspect of the invention, the face organ is at least one of a right eye, a left eye, and a mouth.

The invention can be embodied in various forms. For example, the invention can be embodied in the forms of an image processing method and apparatus, an organ area detecting method and apparatus, a computer program for executing the functions of the apparatuses or the methods, and a computer-readable recording medium having the computer program recorded thereon.

### BRIEF DESCRIPTION OF THE DRAWINGS

The invention will be described with reference to the accompanying drawings, wherein like numbers reference like elements.

FIG. 1 is a block diagram of a printer according to an embodiment of the invention.

FIGS. 2A to 2H are explanatory diagrams illustrating the kinds of face learning data FLD and facial organ learning data OLD.

FIG. 3 is a flowchart of a process of setting a face learning data.

FIG. 4 is an explanatory diagram illustrating an example of a prepared sample image group.

FIG. 5 is an explanatory diagram illustrating an example of a prepared weak identifier group.

FIGS. 6A and 6B are explanatory diagrams illustrating a method of deciding performance ranking of filters.

FIG. 7 is an explanatory diagram schematically illustrating the configuration of an identifier.

FIG. 8 is a flowchart of a process of setting an organ learning data.

FIGS. 9A and 9B are explanatory diagrams illustrating a method of deciding performance ranking of filters.

FIG. 10 is a flowchart of face area and organ area detecting processes.

FIG. 11 is a flowchart of a face area detecting process.

FIG. 12 is an explanatory diagram illustrating an overview of the face area detecting process.

FIGS. 13A and 13B are explanatory diagrams illustrating an overview of a face area determining process.

FIGS. 14A-14C are explanatory diagrams illustrating the overview of the face area determining process.

FIG. 15 is a flowchart of an organ area detecting process.

FIG. 16 is an explanatory diagram illustrating an overview of the face area detecting process.

FIGS. 17A and 17B are explanatory diagrams illustrating an overview of an organ area setting process.

### DESCRIPTION OF EXEMPLARY EMBODIMENTS

Embodiments of the invention are now described in the following order:

### A. Embodiment,

### A-1. Configuration of Image Processing Apparatus,

### A-2. Learning Data Setting Process,

### A-3. Face Area and Organ Area Detecting Processes, and

### B. Modified Examples.

### A. EMBODIMENT

### A-1. Configuration of Image Processing Apparatus

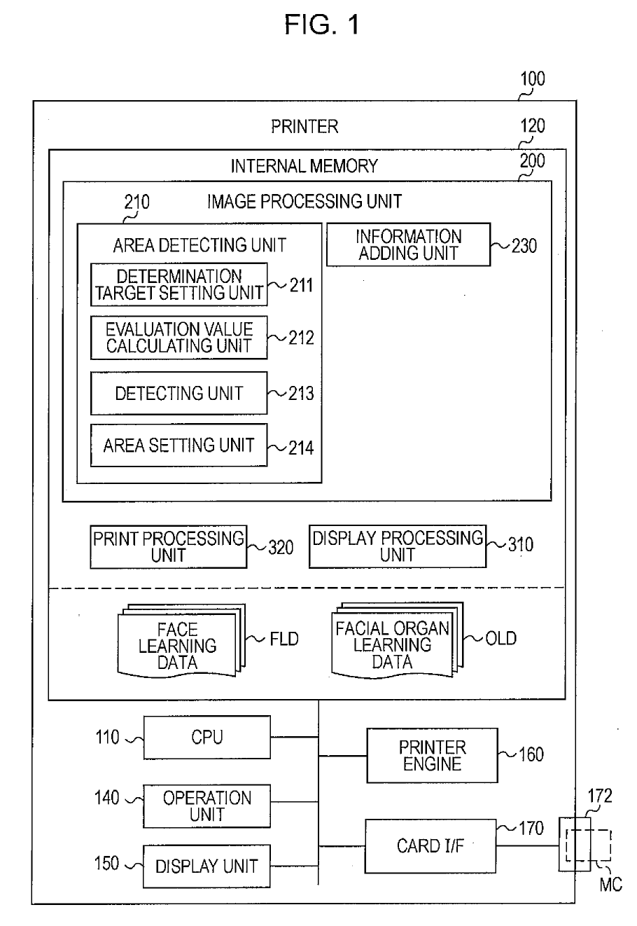

FIG. 1 is a block diagram of a printer 100, which is an image processing apparatus according to the embodiment of the invention. The printer 100 according to this embodiment is an ink jet color printer corresponding to so-called direct printing that prints an image on the basis of image data acquired from a memory card MC or the like. The printer 100 includes a CPU 110 controlling each unit of the printer 100, an internal memory 120 configured by a ROM or a RAM, an operation unit 140 configured by buttons or a touch panel, a display unit 150 configured by a liquid crystal display, a printer engine 160, and a card interface (a card I/F) 170. The printer 100 may additionally include an interface for executing data communication with another apparatus (for example, a digital still camera or a personal computer). Constituent elements of the printer 100 are connected to each other via a bus.

The printer engine 160 is a printing mechanism that performs printing on the basis of print data. The card interface 170 exchanges data with the memory card MC inserted into a card slot 172. In this embodiment, an image file containing image data is stored in the memory card MC.

Internal memory 120 includes an image processing unit 200, a display processing unit 310, and a print processing unit 320. The image processing unit 200 is a computer program for executing a predetermined image process including face area and organ area detecting processes, under a predetermined operating system. The display processing unit 310 is a display driver for displaying a menu, a message, an image, or the like on the display unit 150. The print processing unit 320 is a computer program for generating print data from image data and printing an image on the basis of the print data by controlling the printer engine 160. The CPU 110 reads these programs from the internal memory 120 and executes the read programs to realize functions of these units.

The image processing unit 200 is a program module and includes an area detecting unit 210 and an information adding unit 230. The area detecting unit 210 detects an image area (a face area and an organ area) corresponding to a predetermined subject image (a face image and a facial organ image) in an image represented by the image data. The area detecting unit 210 includes a determination target setting unit 211, an evaluation value calculating unit 212, a detecting unit 213, and an area setting unit 214. The area detecting unit 210 functions as a face area detecting unit and an organ area detecting unit according to the invention in order to detect a face area corresponding to a face image and detect an organ area corresponding to a facial organ image.

The information adding unit 230 adds predetermined information to image files containing image data. A predetermined information adding method is described in detail in the description of the face and organ area detecting processes.

A plurality of preset face learning data FLD and facial organ learning data OLD are stored in the internal memory 120. The face learning data FLD is data for evaluating a certainty that an image area corresponds to a face image. The face learning data FLD is used for the area detecting unit 210 to detect the face area and corresponds to face evaluation data in the invention. The facial organ learning data OLD is data for evaluating a certainty that an image area corresponds to a facial organ image. The facial organ learning data OLD is used for the area detecting unit 210 to detect the organ area and corresponds to organ evaluation data in the invention.

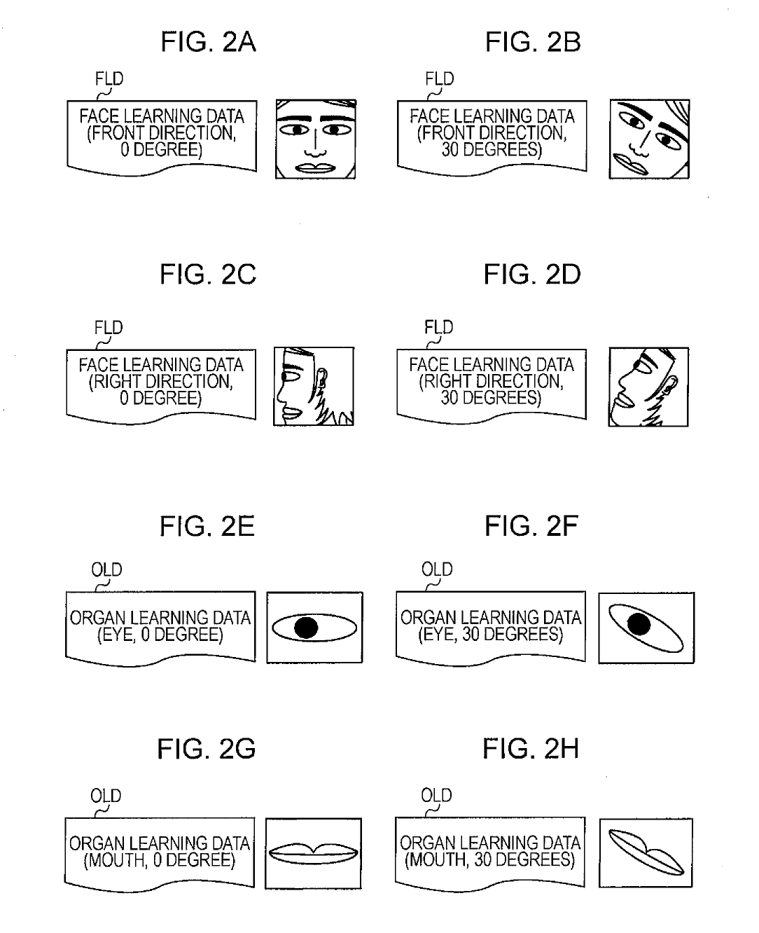

FIGS. 2A-2H are explanatory diagrams illustrating kinds of face learning data FLD and facial organ learning data OLD and examples of image areas detected by use of the kinds of face learning data FLD and facial organ learning data OLD.

Face learning data FLD is set in correspondence with a combination of a face inclination and a face direction. Face inclination means an inclination (a rotation angle) of a face in an image plane (in-plane). That is, face inclination refers to the rotation angle of a face on an axis which is vertical to the image plane. In this embodiment, when a state in which the upper direction of an area or subject is aligned with the upper direction of a target image is referred to as a reference state (inclination=0 degrees), the inclination of the area or subject on the target image is represented as a clockwise rotation angle from the reference state. For example, when a state in which a face is located along a vertical direction of a target image (the top of the head faces upward and the jaw faces downward) is referred to as a reference state (face inclination=0 degrees), the face inclination is represented as a clockwise rotation angle of the face from the reference state.

The face direction means the direction of a face out of an image plane (the angle of a face figure). The face figure means the direction of a face with respect to the axis of a substantially cylindrical neck. That is, the face direction refers to the rotation angle of a face on an axis which is parallel to the image plane. In this embodiment, a “front direction” refers to a face direction of a face looking directly at an imaging surface of an image generating apparatus such as a digital still camera. A “right direction” refers to a face direction of a face turning to the right side of the imaging surface (the image of a face turning to the left side when a viewer views the image). A “left direction” refers to a face direction of a face turning to the left side of the imaging surface (the image of a face turning to the right side when a viewer views the image).

The internal memory 120 stores four face learning data FLD shown in FIGS. 2A-2D: face learning data FLD corresponding to a combination of a face direction of the front direction and a face inclination of 0 degrees (FIG. 2A); face learning data FLD corresponding to a combination of a face direction of the front direction and a face inclination of 30 degrees (FIG. 2B); face learning data FLD corresponding to a combination of a face direction of the right direction and a face inclination of 0 degrees (FIG. 2C); and face learning data FLD corresponding to a combination of a face direction of the right direction and a face inclination of 30 degrees (FIG. 2D). A face in the front direction and a face in the right or left directions may be analyzed as different kinds of subjects. In this case, the face learning data FLD can be represented in correspondence with a combination of the kinds and inclinations of the subjects.

Face learning data FLD corresponding to a certain face inclination is set by learning to detect a face image that is inclined in a range of +15 to −15 degrees from the face inclination. A face of a person is substantially bilaterally symmetric. Therefore, when two face learning data, that is, face learning data FLD corresponding to a face inclination of 0 degrees (FIG. 2A) and face learning data FLD corresponding to a face inclination of 30 degrees (FIG. 2B) are prepared in advance for a face direction of the front direction, it is possible to obtain face learning data FLD that can detect a face image at all face inclinations by rotating the two face learning data FLD in units of 90 degrees. Likewise, when two face learning data, that is, face learning data FLD corresponding to a face inclination of 0 degrees (FIG. 2C) and face learning data FLD corresponding to a face inclination of 30 degrees (FIG. 2D) are prepared in advance for a face direction of the right direction, it is possible to obtain face learning data FLD that can detect a face image at all face inclinations. As for a face direction of the left direction, it is possible to obtain face learning data FLD that can detect a face image at all face inclinations by reversing the face learning data FLD corresponding to the face direction of the right direction.

Facial organ learning data OLD is set in correspondence with a combination of the kinds of facial organs and the organ inclination. In this embodiment, eyes (right and left eyes) and a mouth are used as the kinds of facial organs. The face inclination refers to an inclination (a rotation angle) of a facial organ in an image plane, as in the above-described face inclination. That is, face inclination refers to a rotation angle of a facial organ on an axis which is vertical to the image plane. Like face inclination, when a state in which a facial organ is located in a vertical direction of a target image is referred to as a reference state (organ inclination=0 degrees), the organ inclination is represented as a clockwise rotation angle from the reference state.

The internal memory 120 stores four facial organ learning data OLD shown in FIGS. 2E-2H: facial organ learning data OLD corresponding to a combination of an eye and an organ inclination of 0 degrees (FIG. 2E); facial organ learning data OLD corresponding to a combination of an eye and an organ inclination of 30 degrees (FIG. 2F); facial organ learning data OLD corresponding to a combination of a mouth and an organ inclination of 0 degrees (FIG. 2G); and facial organ learning data OLD corresponding to a combination of a mouth and an organ inclination of 30 degrees (FIG. 2H). Since the eyes and the mouth are different kinds of subjects, the facial organ learning data OLD can be represented in correspondence with a combination of the kinds and inclinations of the subjects.

Like face learning data FLD, facial organ learning data OLD corresponding to a certain organ inclination is set by learning to detect an organ image that is inclined in a range of +15 to −15 degrees from the corresponding organ inclination. The eyes or mouth of a person are substantially bilaterally symmetric. Therefore, as for the eyes, when two facial organ learning data, that is, facial organ learning data OLD corresponding to an organ inclination of 0 degrees (FIG. 2E) and facial organ learning data OLD corresponding to an organ inclination of 30 degrees (FIG. 2F) are prepared in advance, it is possible to obtain facial organ learning data OLD that can detect an eye image at all organ inclinations by rotating the two facial organ learning data OLD in units of 90 degrees. Likewise, for the mouth, when two facial organ learning data, that is, facial organ learning data OLD corresponding to an organ inclination of 0 degrees (FIG. 2G) and facial organ learning data OLD corresponding to an organ inclination of 30 degrees (FIG. 2H) are prepared in advance, it is possible to obtain facial organ learning data OLD that can detect a mouth image at all face inclinations. In this embodiment, the right and left eyes are the same kind of subject and a right eye area corresponding to a right eye image and a left eye area corresponding to a left eye image are detected by use of common facial organ learning data OLD. However, the right and left eyes may be set to different subjects, and respective dedicated facial organ learning data OLD for detecting the right and left eye areas may be prepared.

### A-2. Learning Data Setting Process

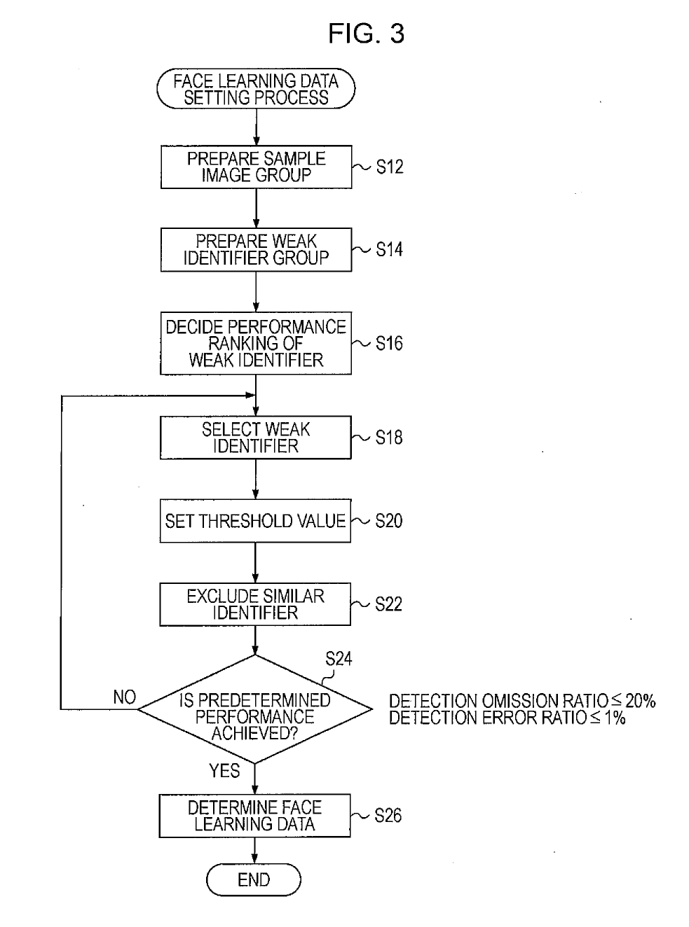

FIG. 3 is a flowchart of a process of setting the face learning data. In this embodiment, the process of setting the face learning data is a process of setting (generating) the face learning data FLD (see FIGS. 1 and 2) by learning by use of a sample image group. As described above, the internal memory 120 stores the four face learning data FLD (see FIGS. 2A-2D) corresponding to four combinations of face directions and face inclinations. The process of setting the face learning data is executed in accordance with each of the four combinations. In this process, the four face learning data FLD are set. The process of setting face learning data is now described in order to set face learning data FLD corresponding to a combination of a face direction of the front direction and a face inclination of 0 degrees (see FIG. 2A).

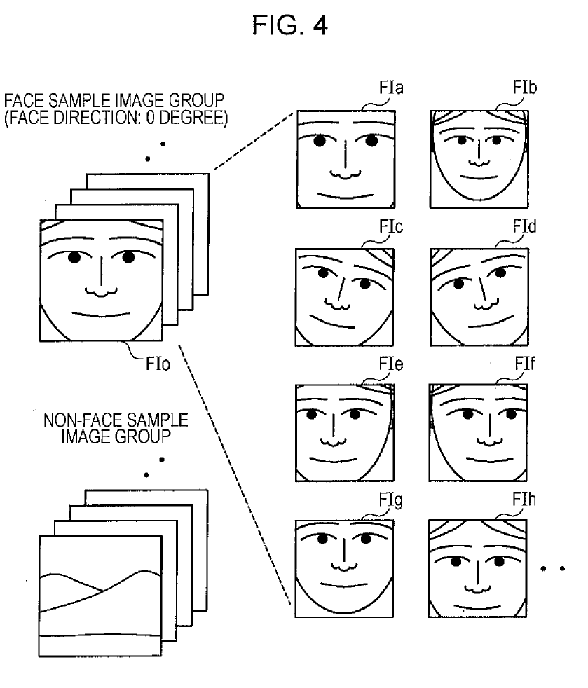

In Step S12 (FIG. 3), a sample image group is prepared. FIG. 4 illustrates an example of a prepared sample image group. As shown in FIG. 4, in Step S12, a face sample image group containing a plurality of face sample images, which are known beforehand to correspond to a face, and a non-face sample image group containing a plurality of non-face sample images, which are known beforehand not to correspond to a face, are prepared. The face sample images are images that contain a face image. The non-face sample images are images that contain no face image. In this embodiment, an image group formed by combining the face sample image group and the non-face sample image group corresponds to a second sample image group according to the invention.

As shown in FIG. 4, the face sample image group contains a plurality of face sample images (hereinafter, also referred to as “basic face sample images FIo”) in which a ratio of the size of the face image with respect to the size of an image is within a predetermined value range and the inclination of the face image is almost 0 degrees. The face sample image group contains, for at least one basic face sample image FIo, face sample images formed by scaling the basic face sample image FIo at a predetermined ratio from 1.2 times to 0.8 times (for example, images FIa and FIb in FIG. 4); face sample images formed by inclining the basic face sample image FIo in the range from −15 to +15 degrees (for example, images FIc and FId in FIG. 4); and face sample images formed by moving the basic face sample image FIo by a predetermined movement distance in vertical and horizontal directions (for example, images FIe to FIh in FIG. 4). In Step S14, a weak identifier group is prepared.

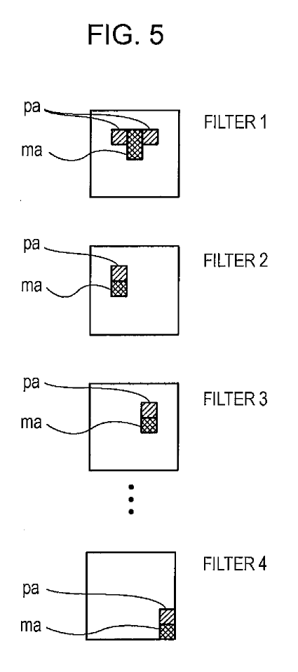

FIG. 5 illustrates an example of a prepared weak identifier group. In this embodiment, N filters (Filters 1-N) are prepared as the weak identifier. Each of the filters functions as a weak identifier constituting the weak identifier group. The outer shape of each filter has the same aspect ratio as that of the outer shape of the face sample image group and the non-face sample image group (see FIG. 4). A plus area pa and a minus area ma are set in each of the filters.

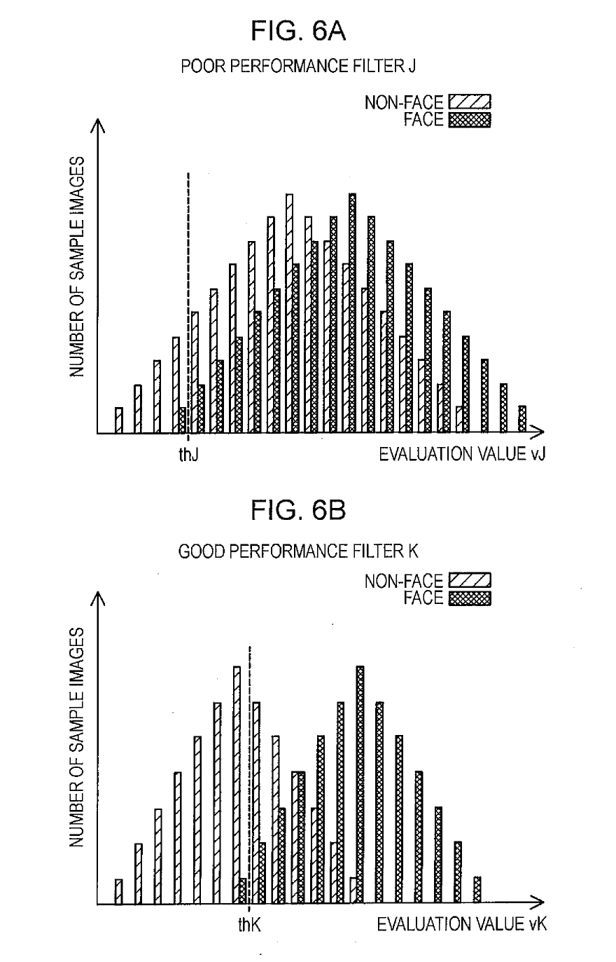

In Step S16, the performance ranking of filters X (where X=1, 2, . . . , N) (see FIG. 5) as the weak identifiers is decided. FIG. 6 illustrates a method of deciding the performance ranking of the filters. When the performance ranking of the filters is decided, evaluation values v of all the face sample images and non-face sample images (hereinafter, collectively referred to as “sample images”) contained in the face sample image group and the non-face sample image group, respectively, are calculated by the filters. The evaluation values v calculated by the filters X (where X=1, 2, . . . , N) are referred to as evaluation values vX (that is, vl to vN). The evaluation value vX is obtained by subtracting the sum of brightness values of pixels located within an area on the sample image corresponding to the minus area ma from the sum of brightness values of pixels located within an area on the sample image corresponding to the plus area pa of the filter X, when the filter X is applied to the sample image so that the outer circumference of the filter X is matched with the outer circumference of the sample image.

When evaluation values v are calculated for all the sample images by use of the filter, a histogram of evaluation values v is created in accordance with the filters shown in FIGS. 6A and 6B, and the performance ranking of the filters is decided on the basis of the histogram. FIG. 6A shows a histogram of evaluation values v (evaluations vJ) for relatively poor performance filters (filters J). FIG. 6B shows a histogram of evaluation values v (evaluation vK) for relatively good performance filters (filters K).

In the histogram of evaluation values vK for the relatively good performance filters K (FIG. 6B), a distribution of evaluation values vK for the face sample images and a distribution of evaluation values vK for the non-face sample images are relatively separate. In contrast, in the histogram of evaluation values vJ for the relatively poor performance filters J (FIG. 6A), a distribution of evaluation values vJ for the face sample images and a distribution of evaluation values vJ for the non-face sample images are not relatively separate. Accordingly, in the relatively good performance filters K, it is easy to set a threshold value th (a threshold value thK) taking a relatively good value for both a face detection omission ratio and a face detection error ratio of a filter. In contrast, in the relatively poor performance filters J, it is difficult to set a threshold value th (a threshold value thJ) taking a relatively good value for both a face detection omission ratio and a face detection error ratio of a filter. Here, the face detection omission ratio of a filter refers to a probability that the filter determines that a face sample image is not an image corresponding to a face. Specifically, the face detection omission ratio of a filter refers to a ratio of the number of face sample images determined as non-face images to the number of face sample images, when the sample images having an evaluation value v equal to or larger than the threshold value th are determined as images corresponding to a face (“face images”) and the sample images having an evaluation value v smaller than the threshold value th are determined as images not corresponding to a face (“non-face images”). In addition, the face detection error ratio of a filter is a probability that the filter determines that a non-face sample image is an image corresponding to a face. Specifically, the face detection error ratio of a filter is a ratio of the number of non-face sample images determined as face images to the number of non-face sample images.

In this embodiment, as a specific reference for deciding the performance ranking of the filters, there is used the face detection error ratio of a filter when a threshold value th having a face detection omission ratio of about 0.5% is set. FIGS. 6A and 6B show the threshold value th set in this manner. Since the number of non-face sample images having an evaluation value v equal to or larger than the threshold value th is smaller in the histogram for the filters K (FIG. 6B) than in the histogram for the filters J (FIG. 6A), it can be seen that the face detection error ratio of the filter K is relatively low, that is, that the performance of the filters K is relatively good. The performance ranking of all the filters X (Filters 1-N) is decided on the basis of this reference.

In Step S18, a filter is selected as one weak identifier. The selected filter is a filter having the best performance among the filers not selected. In Step S20, a threshold value th for the selected filter is set. As described above, the threshold value th is set such that the face detection omission ratio of the filter is about 0.5%.

In Step S22, a process of excluding a weak identifier (filter) similar to the weak identifier (filter) selected in previous Step S18 from selection candidates is executed. This excluding process is executed because face detection can be executed more effectively in using filters not similar to each other than in using a plurality of filters similar to each other. In addition, each filter has information on similarity between the filters and the process of excluding the filter is executed on the basis of this information.

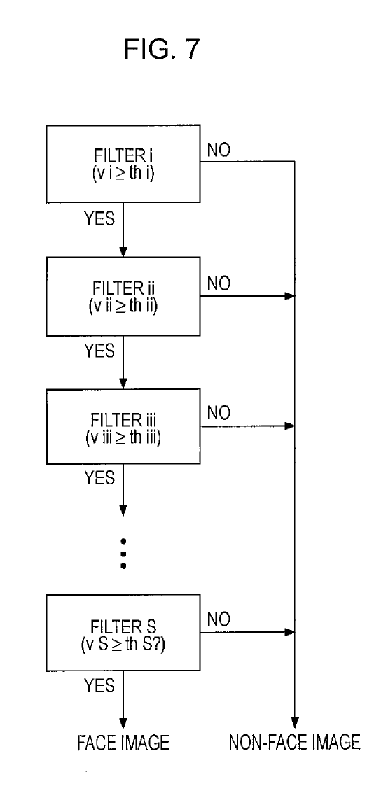

In Step S24, it is determined whether an identifier formed by connecting the selected weak identifiers in series achieves a predetermined performance. FIG. 7 illustrates the configuration of the identifier. As shown in FIG. 7, the identifier has a configuration in which a first selected filter (filter i) to an S-th selected filter (filter S) are sequentially connected in series. A specific threshold value th in Step S20 is set in each of the filers. When the face of a target image area is determined by use of the identifier, a determination is executed by comparing the evaluation value v of each filter to the threshold value th thereof. Then, it is determined that the target image area is not the face image (the non-face image), at the time of determining that the target image area is not the face image in one filter. When it is determined that the target image area is the face image in all the filters forming the identifier, it is determined that the target image area is the face image.

In each of the filters forming the identifier, the face detection omission ratio and the face detection error ratio are defined in accordance with the set threshold value th. In Step S24, it is determined whether the face detection omission ratio and the face detection error ratio in the identifier formed by connecting the selected weak identifiers in series satisfies predetermined conditions, specifically, that the face detection omission ratio is 20% or less and the face detection error ratio is 1% or less.

The determination (face determination) made as to whether the target image area is a face image or a non-face image in each filter is executed only for sample images determined to be a face image in the previous filter. Therefore, when the number of filters forming the identifier is increased, the face detection error ratio of all the identifiers is decreased. Alternatively, when the number of filters forming the identifier increases, the face detection omission ratio increases. In Step S24, it is determined whether the face detection error ratio is a predetermined threshold value (1%) or less in the range of the face detection omission ratio of a predetermined threshold value (20%) or less.

Alternatively, when the identifier does not achieve the predetermined performance in Step S24, the process returns to Step S18. Then, the weak identifier having the best performance is selected from among the weak identifiers not selected and Steps S20-S24 are again executed. Alternatively, when the identifier achieves the predetermined performance in Step S24, the face learning data FLD defining the identifier formed by connecting the selected weak identifiers in series is decided.

The face learning data setting process of setting face learning data FLD corresponding to a combination of a face direction of the front direction and a face inclination of 0 degrees (FIG. 2A) has been described. However, a face learning data setting process of setting each of the face learning data FLD corresponding to each of the other combinations (FIGS. 2B-2D) is executed in the same manner, except that the used face sample images (FIG. 4) correspond to the combinations.

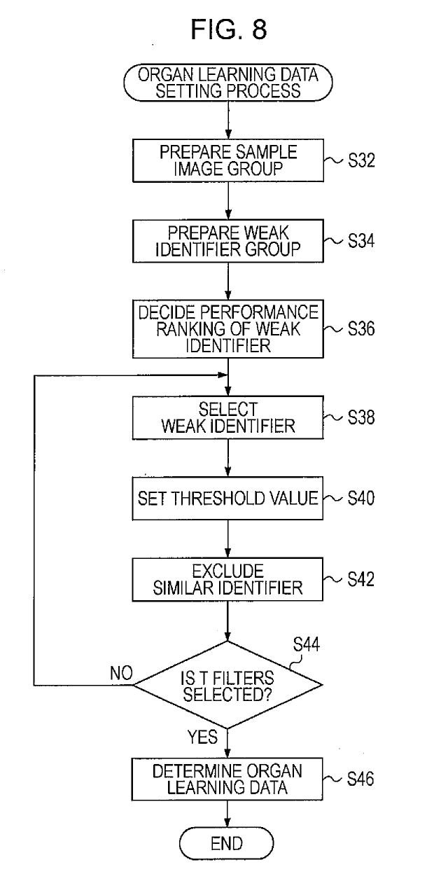

FIG. 8 is a flowchart illustrating a process of setting the organ learning data. In this embodiment, the process of setting the organ learning data is a process of setting (generating) the facial organ learning data OLD (see FIG. 1 and FIGS. 2A-2H) by learning by use of the sample image group. As described above, the internal memory 120 stores the four facial organ learning data OLD (see FIGS. 2E-2H) corresponding to four combinations of organs and organ inclinations. The process of setting the organ learning data is executed in accordance with each of the four combinations, and the four facial organ learning data OLD is set.

The details of the process of setting the organ learning data (FIG. 8) are almost the same as the details of the process of setting the face learning data described above (FIG. 3). That is, in the process of setting the organ learning data, the sample image groups and the weak identifier group are prepared (Steps S32 and S34) and the performance ranking of the weak identifier groups is decided (Step S36).

The prepared sample image group is an organ sample image group containing a plurality of organ sample images, which are known beforehand to correspond to facial organs, and a non-organ sample image group containing a plurality of non-face sample images, which are known beforehand not to correspond to facial organs. The organ sample images each contain a facial organ image. The non-organ sample images contain no facial organ image. Like the face sample image group (FIG. 4), the organ sample image group contains: the basic organ sample image; organ sample images formed by scaling a basic organ sample image at a predetermined ratio; organ sample images formed by inclining a basic organ sample image; and organ sample images formed by moving the location of a facial organ image in the basic organ sample image by a predetermined movement distance in vertical and horizontal directions. In this embodiment, an image group formed by combining an organ sample image group and a non-organ sample image group corresponds to a first sample image group according to the invention.

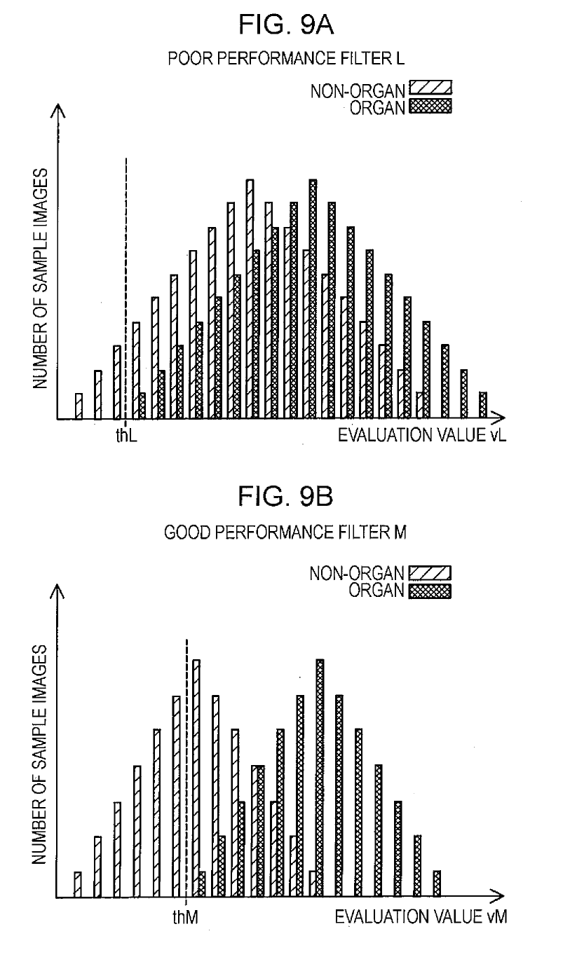

The performance ranking of the weak identifier groups is decided in substantially the same manner as the manner in which the performance ranking of the weak identifier groups is decided in the process of setting the face learning data. FIG. 9 illustrates a method of deciding the performance ranking of the filters. When the performance ranking of the filters is decided, evaluation values v of all organ sample images and non-organ sample images contained in the organ sample image group and the non-organ sample image group, respectively, are calculated by the filters. In addition, the performance ranking of the filters is decided on the basis of the histograms (FIGS. 9A and 9B) of the evaluation values v in accordance with the filters. FIG. 9A shows a histogram of evaluation values v (evaluations vL) for relatively poor performance filters (filters L). FIG. 9B shows a histogram of evaluation values v (evaluation vM) for relatively good performance filters (filters M). In this embodiment, as a specific reference for deciding the performance ranking of the filters, there is used an organ detection error ratio of a filter when a threshold value th having an organ detection omission ratio of about 0% is set. FIGS. 9A and 9B show the threshold value th set in this manner. Since the number of non-organ sample images having an evaluation value v equal to or larger than the threshold value th is smaller in the histogram for the filters M (FIG. 9B) than in the histogram for the filters L (FIG. 9A), it can be seen that the organ detection error ratio of the filter M is relatively low, that is, the performance of the filters M is relatively good. The organ detection omission ratio of a filter refers to a probability that the filter determines that an organ sample image is not an image corresponding to a facial organ. Specifically, the organ detection omission ratio of a filter refers to a ratio of the number of organ sample images determined as non-organ images to the number of organ sample images, when sample images having an evaluation value v equal to or larger than the threshold value th are determined as images corresponding to facial organs (“organ images”), and sample images having an evaluation value v smaller than the threshold value th are determined as images not corresponding to facial organs (“non-organ images”). The organ detection error ratio of a filter is a probability that the filter determines that a non-organ sample image is an image corresponding to a facial organ. Specifically, the organ detection error ratio of a filter is a ratio of the number of non-organ sample images determined as organ images to the number of non-organ sample images.

Subsequently, the filter having the best performance among the filters not selected is selected (Step S38) and the threshold value th for the selected filter is set (Step S40). A process of excluding a weak identifier (filter) similar to the weak identifier (filter) selected in previous Step S38 from selection candidates is executed (Step S42). As described above, the threshold value th is set such that the organ detection omission ratio of the filter is about 0%.

In Step S44 (FIG. 8), it is determined whether T filters are selected. When T filters are not selected, the process returns to Step S38. Then, the weak identifier having the best performance is selected among the weak identifiers not selected and Steps S40-S44 are again executed. Alternatively, when T filters are selected in Step S44, the facial organ learning data OLD defining the identifier formed by connecting the selected weak identifiers in series is decided.

A T value is set in advance. Specifically, the T value is set to be smaller than the number of filters forming the identifier (S in the example of FIG. 7) defined by the face learning data FLD.

In the process of setting the organ learning data (FIG. 8), since the threshold value th of the selected filter is set such that the organ detection omission ratio of the filter is 0%, the organ detection omission ratio of all identifiers defined by facial organ learning data OLD is 0%. Therefore, the organ detection omission ratio of all identifiers defined by facial organ learning data OLD is smaller than the face detection omission ratio of all identifiers defined by face learning data FLD. On the other hand, since a condition determination for the organ detection error ratio is not executed in the determination in Step S44, the organ detection error ratio of all identifiers defined by facial organ learning data OLD depends on the T value. In this embodiment, since the T value is set to be smaller than the number of filters forming the identifier defined by face learning data FLD, the organ detection error ratio of all identifiers defined by facial organ learning data OLD is therefore larger than the face detection error ratio of all identifiers defined by face learning data FLD.

Any appropriate method can be used as a learning method used in the processes of setting the face learning data and organ learning data, such as, for example, a method using a neural network, a method using boosting (for example, AdaBoosting), and a method using a support vector machine).

### A-3. Face Area and Organ Area Detecting Processes

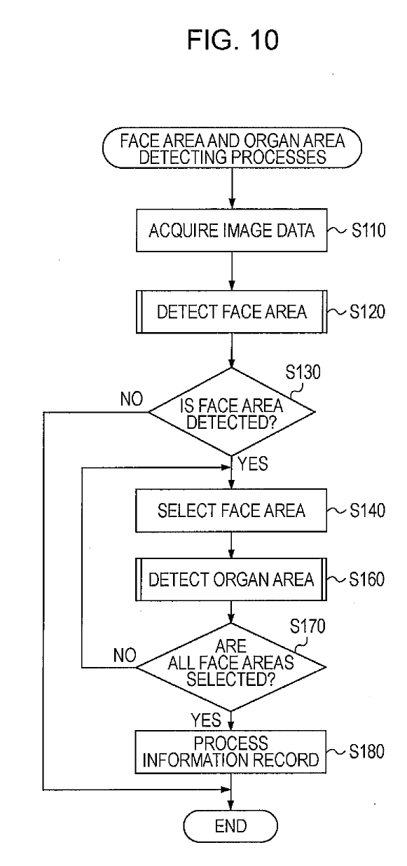

FIG. 10 is a flowchart of face area and organ area detecting processes. In this embodiment, the face area and organ area detecting processes are processes of detecting a face area corresponding to a face image in an image represented by image data, and of detecting an organ area corresponding to a facial organ in the face area, respectively. The detected face and organ areas can be used in predetermined image processing, such as skin color correction, red-eye correction, face image deformation, or facial expression (smile face or the like) detection.

In Step S110 (FIG. 10), the image processing unit 200 (FIG. 1) acquires image data representing images as targets of the face area and organ area detecting processes. In the printer 100 according to this embodiment, when a memory card MC is inserted into the card slot 172, thumbnail images of an image file stored in the memory card MC are displayed on the display unit 150. Referring to the displayed thumbnail images, a user selects one or a plurality of images as processing targets through the operation unit 140. The image processing unit 200 acquires an image file containing image data corresponding to the selected images from the memory card MC and stores the acquired image file in a predetermined area of the internal memory 120. The acquired image data is referred to as original image data, and the image representing by the original data is referred to as an original image OImg.

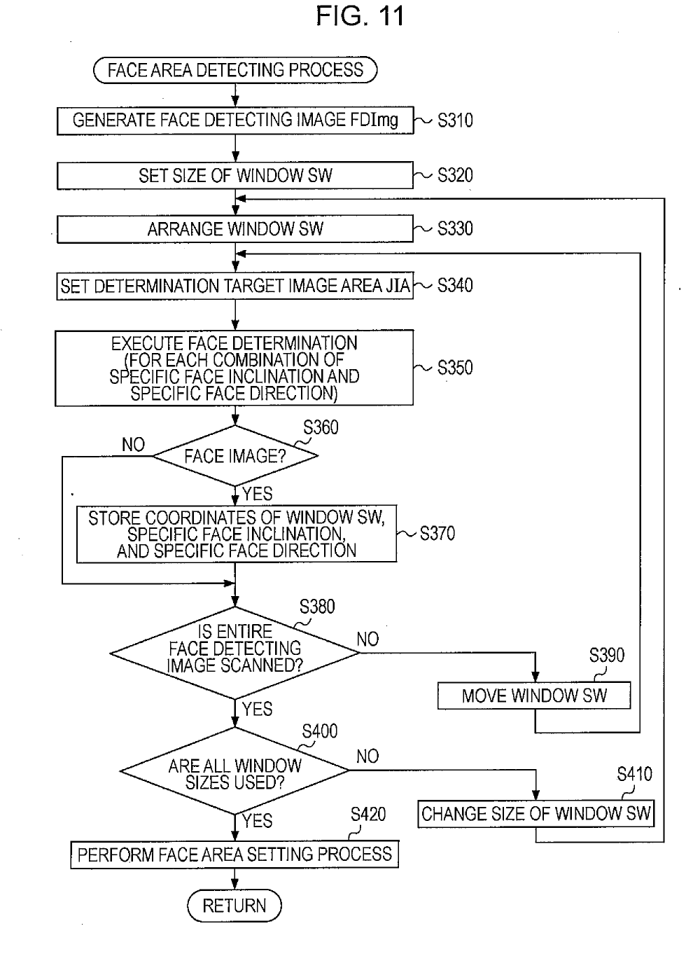

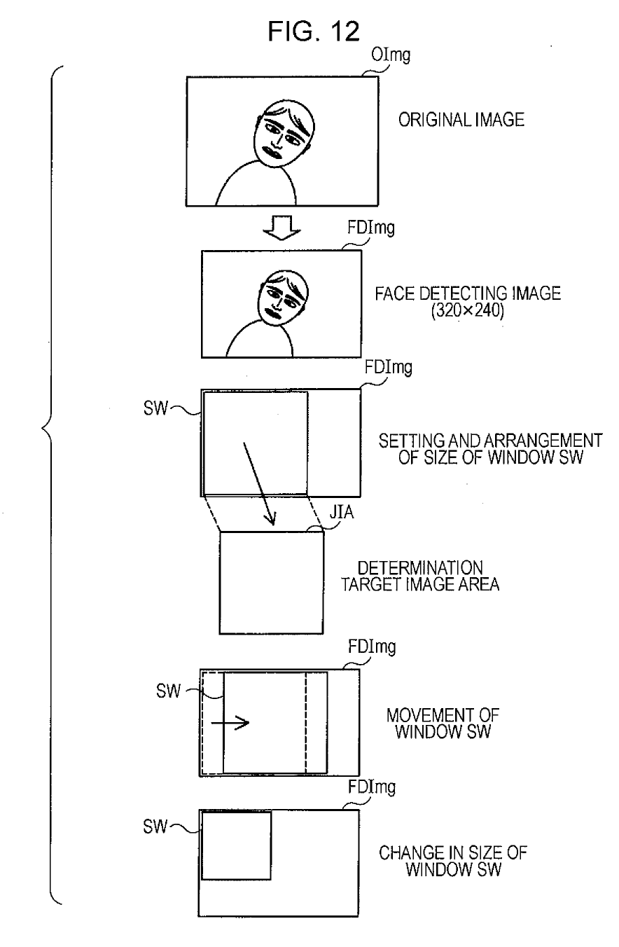

In Step S120 (FIG. 10), the area detecting unit 210 executes the face area detecting process. The face area detecting process is a process of detecting as a face area FA an image area corresponding to a face image. FIG. 11 is a flowchart of the face area detecting process. FIG. 12 is an overview of the face area detecting process. An example of an original image OImg is illustrated in the uppermost part of FIG. 12.

In Step S310 of the face area detecting process (FIG. 11), the area detecting unit 210 generates face detecting image data representing a face detecting image FDImg from the original image data representing the original image OImg. In this embodiment, as shown in FIG. 12, the face detecting image FDImg is an image having a size of horizontal 320 pixels×vertical 240 pixels. The area detecting unit 210 generates face detecting image data representing the face detecting image FDImg by converting the resolution of the original image data, if necessary.

In Step S320, the determination target setting unit 211 sets the size of a window SW used to set a determination target image area JIA to an initial value. In Step S330, the determination target setting unit 211 arranges the window SW at an initial location on the face detecting image FDImg. In Step S340, the determination target setting unit 211 sets the image area defined by the window SW disposed on the face detecting image FDImg to the determination target image area JIA, which is a target of a determination (“face determination”) as to whether the image area corresponds to a face image. In the middle part of FIG. 12, a window SW having the size of the initial value is arranged at an initial location on the face detecting image FDImg, and the image area defined by the window SW is set as the determination target image area JIA. In this embodiment, the setting of the determination target image area JIA is executed in order, while the size and location of the square window SW is changed. In this case, the initial size of the window SW is horizontal 240 pixels×vertical 240 pixels, which is the maximum size. In addition, the initial location of the window SW is a location where the upper-left apex of the window SW overlaps with the upper-left apex of the face detecting image FDImg. The window SW is arranged such that its inclination is 0 degrees. As described above, the inclination of the window SW refers to a clockwise rotation angle from a reference state in which the upper direction of the window SW is aligned with the upper direction of the target image (the face detecting image FDImg) (inclination=0 degrees).

In Step S350 (see FIG. 11), the face determination is executed using the face learning data FLD. The face determination is executed in accordance with each of the combinations of the preset specific face inclinations and the preset specific face directions. That is, it is determined whether the determination target image area JIA corresponds to a face image having the specific face inclination and the specific face direction, by use of the face learning data FLD corresponding to the combination in accordance with the combination of the specific face inclination and direction. The specific face inclination refers to a predetermined face inclination. In this embodiment, a reference face inclination (face inclination=0 degrees) and face inclinations obtained by increasing the face inclination from the reference face inclination by every 30 degrees, that is, a total of twelve face inclinations (0, 30, 60, . . . , and 330 degrees) are set as the specific face inclinations. The specific face direction refers to a predetermined face direction. In this embodiment, a total of three face directions (front, right and left) are set as the specific face directions. In the face determination, the face learning data FLD stored in the internal memory 120 is used, or the face learning data FLD stored in the internal memory 120 is generated and the face learning data FLD is used.

As described above, the face learning data FLD defines the identifier (FIG. 7) used for the face determination. The face determination is executed by use of the identifier defined by face learning data FLD. That is, in each of the filters forming the identifier, the evaluation value calculating unit 212 (see FIG. 1) calculates an evaluation value v for the determination target image area JIA on the basis of the image data corresponding to the determination target image area JIA. The determining unit 213 compares the calculated evaluation value v to the preset threshold value th. When the evaluation value v is equal to or larger than the threshold value th, it is determined that the determination target image area JIA corresponds to a face image in the filter. Alternatively, when the evaluation value v is smaller than the threshold value th, it is determined that the determination target image area JIA does not correspond to a face image in the filter. It is determined that the determination target image area JIA does not correspond to a face image at the time of determining that the determination target image area JIA is not a face image corresponding to the face image in one filter. When the determination target image area JIA corresponds to a face image in all the filters forming the identifier, it is determined that the determination target image area JIA corresponds to a face image.

When the determination target image area JIA corresponds to a face image (Yes in Step S360), the area detecting unit 210 stores the location of the determination target image area JIA, that is, the presently set coordinates of the window SW, the specific face inclination, and the specific face direction (Step S370). Alternatively, when the determination target image area JIA does not correspond to a face image for the combination of a specific face inclination and a specific face direction (No in Step S360), Step S370 is skipped.

In Step S380, the area detecting unit 210 determines whether the entire face detecting image FDImg is scanned by the window SW having the presently set size. When the entire face detecting image FDImg is not scanned, the determination target setting unit 211 moves the window SW by a predetermined movement distance in a predetermined direction (Step S390). In the low part of FIG. 12, the movement of the window SW is shown. In this embodiment, in Step S390, the window SW is moved in the right direction by a movement distance of 20% of the size in the horizontal direction of the window SW. When the window SW cannot be further moved in the right direction, it is returned to the left end of the face detecting image FDImg and moved a downward direction by a movement distance of 20% of the size in the vertical direction of the window SW in Step S390. When the window SW cannot be further moved in the downward direction, the entire face detecting image FDImg is scanned. After the movement of the window SW (Step S390), the processes subsequent to Step S340 are executed on the moved window SW.

When the entire face detecting image FDImg is scanned by the window SW of the presently set size in Step S380, it is determined whether all predetermined sizes of the window SW are used (Step S400). In this embodiment, as the size of the window SW, a total of fifteen sizes: horizontal 213 pixels×vertical 213 pixels; horizontal 178 pixels×vertical 178 pixels; horizontal 149 pixels×vertical 149 pixels; horizontal 124 pixels×vertical 124 pixels; horizontal 103 pixels×vertical 103 pixels; horizontal 86 pixels×vertical 86 pixels; horizontal 72 pixels×vertical 72 pixels; horizontal 60 pixels×vertical 60 pixels; horizontal 50 pixels×vertical 50 pixels; horizontal 41 pixels×vertical 41 pixels; horizontal 35 pixels×vertical 35 pixels; horizontal 29 pixels×vertical 29 pixels; horizontal 24 pixels×vertical 24 pixels; and horizontal 20 pixels×vertical 20 pixels (the minimum size), in addition to the size of horizontal 240 pixels×vertical 240 pixels as the initial value (the maximum size), are set. When there is a window WS not used, the determination target setting unit 211 changes the size of the window SW from the presently set size to the next smaller size (Step S410). That is, the size of the window SW is initially the maximum size and then changed to the smaller size in order. After the size of the window SW is changed (Step S410), the processes subsequent to Step S330 are executed on the window SW of which the size is changed.

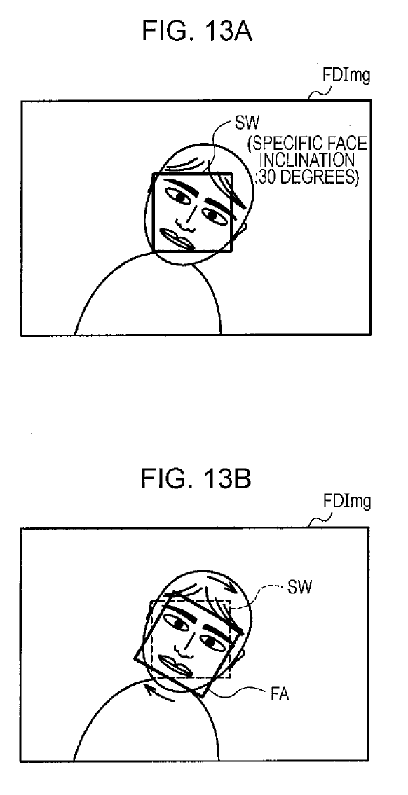

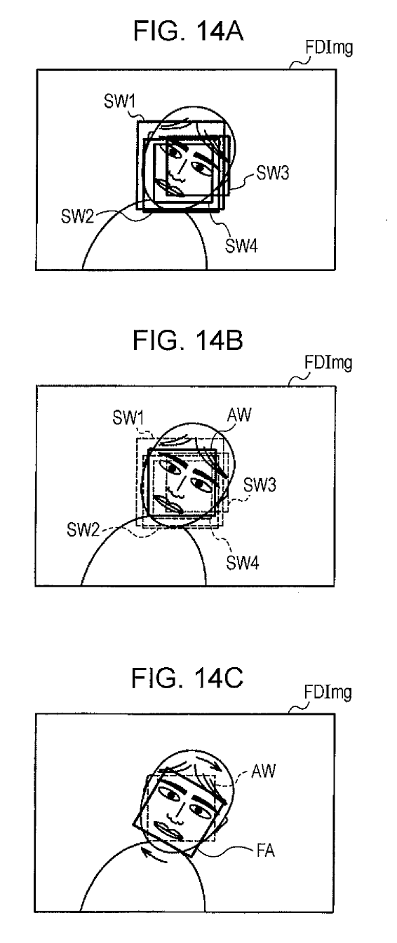

When all the predetermined sizes of the window SW are used, the area setting unit 214 executes the face area determining process (Step S420). FIGS. 13A and 13B and FIGS. 14A-14C are an overview of the face area determining process. The area setting unit 214 decides a face area FA as the image area corresponding to a face image on the basis of the coordinates of the window SW and the specific face inclination stored in Step S370, when it is determined that the determination target image area JIA corresponds to the face image in the face determination (Step S350) of FIG. 11. Specifically, when the stored specific face inclination is 0 degrees, the image area (that is, the determination target image area JIA) defined by the window SW is decided as the face area FA. On the other hand, when the stored specific face inclination is an inclination other than 0 degrees, the inclination of the window SW is made equal to the specific face inclination (that is, the window SW is rotated clockwise about a predetermined point (for example, a central point of the window SW) by the specific face inclination). Then, the image area defined by the window SW subjected to inclination change is decided as the face area FA. For example, in FIG. 13A, when it is determined that a cumulative evaluation value TV is equal to or larger than a threshold value TH for the specific face inclination of 30 degrees, the inclination of the window SW is changed to 30 degrees, as shown in FIG. 13B. Then, the image area defined by the window SW of which the inclination is changed is decided as the face area FA.

When a plurality of the windows SW partially overlap with each other for a specific face inclination in Step S370, the area setting unit 214 sets a new window having an average size of the sizes of the windows SW (“average window AW”), using average coordinates of the coordinates of the predetermined points of the windows SW (for example, the central point of each window SW) as the center of gravity. For example, FIG. 14A shows four windows SW (SW1-SW4) that partially overlap with each other. In FIG. 14B, the average coordinates of the central coordinates of the four windows SW is used as the center of gravity. Then, one average window AW having the average size of the sizes of the four windows SW is defined. At this time, as described above, when the stored specific face inclination is 0 degrees, the image area defined by the average window AW is decided as the face area FA. Alternatively, when the stored specific face inclination is an inclination other than 0 degrees, the inclination of the average window AW is made equal to the specific face inclination (that is, the average window AW is rotated clockwise about a predetermined point (for example, the central point of the average window AW) by the specific inclination). Then, an image area defined by the average window AW subjected to inclination change is decided as the face area FA (FIG. 14C). As shown in FIGS. 13A and 13B, even when one window SW that does not overlap with another window SW is stored, the one window SW can be analyzed as the average window AW, as in the case of FIGS. 14A-14C where a plurality of windows SW partially overlapping with each other are stored. In this embodiment, images (for example, the images FIa and FIb in FIG. 4) formed by scaling the basic face sample image FIo at a predetermined ratio from 1.2 times to 0.8 times are contained in the face sample image group (see FIG. 4). Therefore, even when the size of the face image for the size of the window SW is slightly larger or smaller than that of the basic face sample image FIo, the face area FA can be detected. Accordingly, in this embodiment, as standard sizes of the window SW, only the above-described fifteen discrete sizes are set, but the face area FA can be detected for face images having all sizes. Likewise, in this embodiment, images (for example, the images FIc and FId in FIG. 4) formed by inclining the basic face sample image FIo in the range from −15 to +15 degrees are contained in the face sample image group. Therefore, even when the inclination of the face image with respect to the window SW is slightly different from that of the basic face sample image FIo, the face area FA can be detected. Accordingly, in this embodiment, as the specific face inclination, only the above-described twelve discrete sizes are set, but the face area FA can be detected for face images inclined at all angles.

When the face area FA is not detected (No in Step S130 of FIG. 10) in the face area detecting process (Step S120), the face area and organ area detecting processes end. Alternatively, when at least one face area FA is detected (Yes in Step S130), the area detecting unit 210 selects one of the detected face areas FA (Step S140).

In Step S160, the area detecting unit 210 executes the organ area detecting process. The organ area detecting process is a process of detecting as an organ area an image area corresponding to a facial organ image in the face area FA selected in the Step S140. In this embodiment, since the eyes (right and left eyes) and the mouth are set as the kinds of facial organs, a right eye area EA(r) corresponding to a right eye image, a left eye area EA(l) corresponding to a left eye image, and a mouth area MA corresponding to a mouth image are detected in the organ area detecting process (hereinafter, the right eye area EA(r) and the left eye area EA(l) are referred to collectively as “eye area EA”).

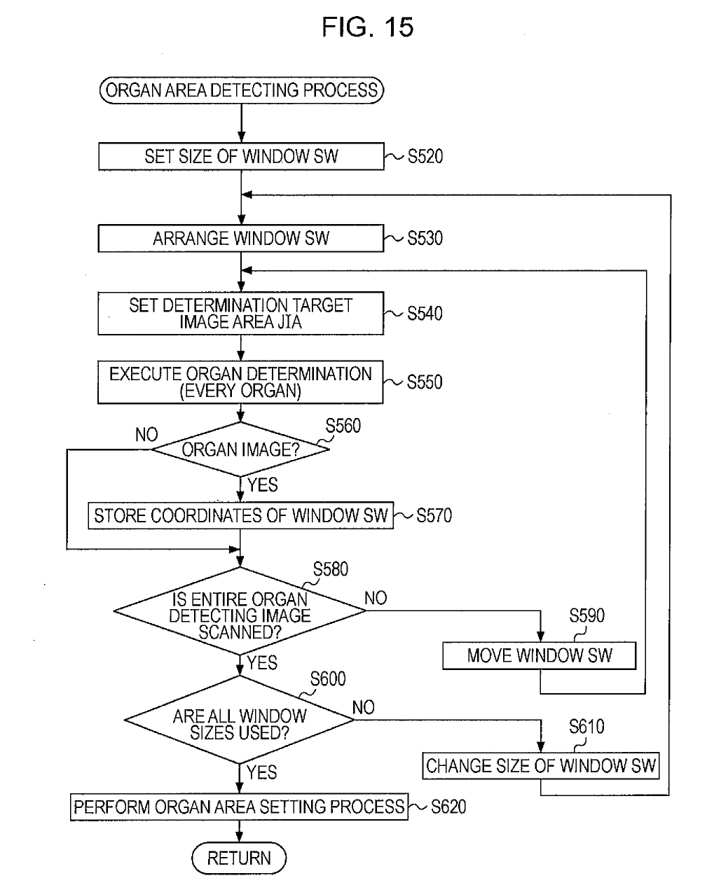

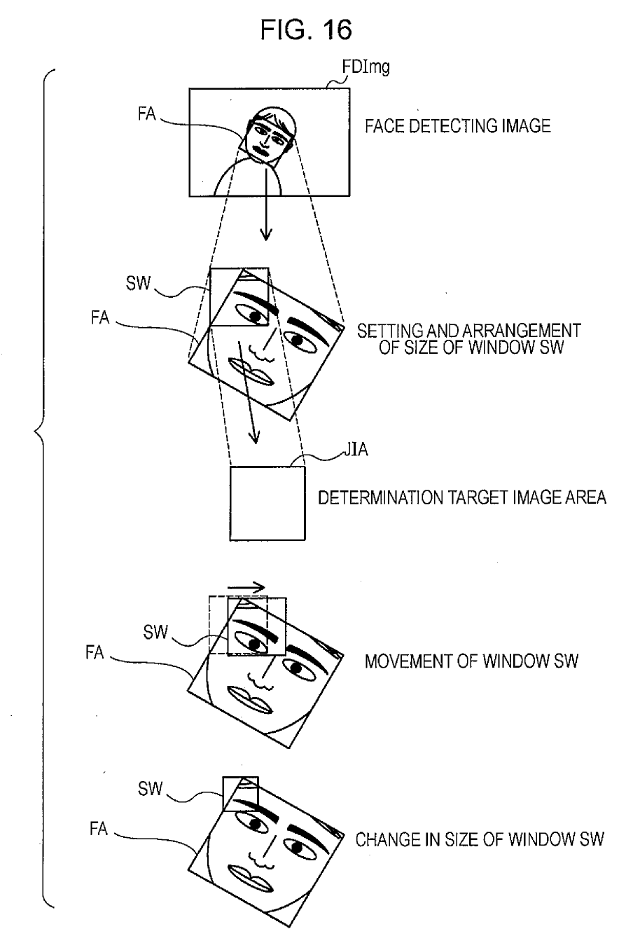

FIG. 15 is a flowchart of the organ area detecting process. FIG. 16 is an overview of the organ area detecting process. An example of the face detecting image FDImg (see FIG. 12) used for the face detecting process is illustrated in the uppermost part of FIG. 16.

The process of detecting the organ area from the face detecting image FDImg is executed in the same manner as that of the above-described process of detecting the face area FA. That is, as shown in FIG. 16, a rectangular window SW is arranged on the face detecting image FDImg while changing the location and the size of the window SW (Steps S520 and S530 and Steps S580-S610 of FIG. 15). In addition, the image area defined by the arranged window SW is set as a determination target image area JIA which is a target of a determination (“organ determination”) as to whether the image area is an organ area corresponding to a facial organ image (Step S540 of FIG. 15). The window SW is arranged in a state where the inclination of the window SW is 0 degrees (a reference state where the upper direction of the window SW is aligned with the upper direction of the face detecting image FDImg).

When the determination target image area JIA is set, the organ determination is executed by use of facial organ learning data OLD (see FIG. 1) in accordance with the facial organs (the eyes and the mouth) (Step S550 of FIG. 15). The method of determining the organs is the same as the method of determining the face (Step S350 of FIG. 11) in the face area detecting process. In this case, the face determination in the face area detecting process is executed for all specific face inclinations. In contrast, the organ determination in the organ area detecting process is executed for only the same organ inclination as the specific face inclination of the face area FA, using the facial organ learning data OLD (see FIGS. 2E-2H) corresponding to the same organ inclination as the specific face inclination of the selected face area FA. However, even in the organ area detecting process, the organ determination may be executed for all specific organ inclinations.

When it is determined that the determination target image area JIA corresponds to a facial organ image, the location of the determination target image area JIA, that is, the presently set coordinates of the window SW is stored (Step S570 of FIG. 15). Alternatively, when the determination target image area JIA does not correspond to a facial organ image, Step S570 is skipped.

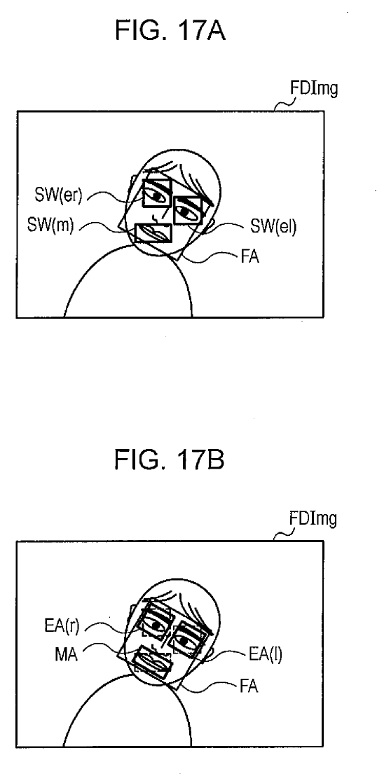

After the entire range of locating the window SW is scanned, the area setting unit 214 executes the organ area setting process on all sizes that the window SW can have (Step S620 of FIG. 15). FIGS. 17A and 17B are an overview of the organ area setting process. The organ area setting process is the same process as the face area setting process (FIGS. 13A and 13B and FIGS. 14A-14C). The area setting unit 214 determines that the determination target image area JIA corresponds to a facial organ image in Step S560 and sets the organ area as an image area corresponding to the facial organ image on the basis of the coordinates of the window SW stored in Step S570 and the specific face inclination corresponding to the face area FA. Specifically, when the specific face inclination is 0 degrees, the image area (the determination target image area JIA) defined by the window SW is set as the organ area. On the other hand, when the specific face inclination is an inclination other than 0 degrees, the inclination of the window SW is made equal to the specific face inclination (that is, the window SW is rotated clockwise about a predetermined point (for example, the central point of the window SW) by the specific face inclination). Then, the image area defined by the window SW of which the inclination is changed is decided as the organ area. For example, in FIG. 17A, when it is determined that each of cumulative evaluation values Tv in a window SW(er) corresponding to the right eye, a window SW(el) corresponding to the left eye, and a window SW(m) corresponding to the mouth is equal to or larger than a threshold value TH for the specific face inclination of 30 degrees, the inclination of each of the windows SW is changed to 30 degrees, as shown in FIG. 17B. Then, the image area defined by each of the windows SW of which the inclination is changed is decided as the organ area (the right eye area EA(r), the left eye area EA(l), and the mouth area MA).

Like the face area setting process, when a plurality of windows SW partially overlapping with each other are stored, the average coordinates of a predetermined point of each of the windows SW (for example, the central point of each window SW) is set as the center of gravity and one new window (the average window AW) having the average size of the sizes of the windows SW is set. When the specific face inclination is 0 degrees, the image area defined by the average window AW is set as the organ area. On the other hand, when the specific face inclination is an inclination other than 0 degrees, the inclination of the average window AW is made equal to the specific face inclination (that is, the average window AW is rotated clockwise about a predetermined point (for example, the central point of the average window AW) by the specific inclination). Then, the image area defined by the average window AW subjected to inclination change is set as the organ area.

In Step S170 (see FIG. 10) of the face area and organ area detecting processes, the area detecting unit 210 determines whether a face area FA that is not selected in Step S140 is present. When a face area FA that is not selected is present (No in Step S170), the process returns to Step S140. Then, one of face areas FA that is not selected is selected and the organ area detecting process of Step S160 is executed. Alternatively, when all face areas FA are selected (Yes in Step S170), the process proceeds to Step S180.

In Step S180, the information adding unit 230 executes information record processing of adding auxiliary information to the image file contained in the original image data. The information adding unit 230 stores information (information on the location (coordinates) of the face area and the organ areas in the original image OImg) specifying the area face and the organ areas detected as the auxiliary information in an auxiliary information storing area of the image file contained in the original image data. Moreover, the information adding unit 230 may store information on the size of the face area and the organ areas or information on the inclination of the face area and the organ areas in the original image OImg in the auxiliary information storing area.

As described above, in the face and organ area detecting processes in the printer 100 according to this embodiment, the face and organ areas are detected from the target image by use of face learning data FLD and facial organ learning data OLD. As described above, face learning data FLD and facial organ learning data OLD are set such that the organ detection omission ratio of all identifiers defined by facial organ learning data OLD is smaller than the face detection omission ratio of all identifiers defined by face learning data FLD. Therefore, the organ detection omission ratio in the organ area detecting process (see FIG. 15) executed by the area detecting unit 210 is smaller than the face detection omission ratio in the face area detecting process (see FIG. 11) executed by the area detecting unit 210. Accordingly, in the face and organ area detecting processes in the printer 100 according to this embodiment, it is possible to prevent organ area detection omission from occurring.

As a result of setting the face learning data FLD and the facial organ learning data OLD such that the organ detection omission ratio of all identifiers defined by facial organ learning data OLD is smaller than the face detection omission ratio of all identifiers defined by face learning data FLD, the organ detection error ratio of all the identifiers defined by facial organ learning data OLD is larger than the face detection error ratio of all identifiers defined by face learning data FLD. Therefore, the organ detection error ratio in the organ area detection process (see FIG. 15) executed by the area detecting unit 210 is larger than the face detection error ratio in the face area detecting process (see FIG. 11) executed by the area detecting unit 210. However, when detection of a face area is executed on a face detecting image FDImg and a face area is detected, it is not clear whether a face image is contained in the face detecting image FDImg. Moreover, when a face image is contained in the face detecting image FDImg, it is not clear what number of face images are contained. On the other hand, when detection of the organ area is executed on a face area FA and an organ area is detected, there is a high probability that a facial organ image is contained in the face area FA. Moreover, the total number of facial organ images contained in the face area FA is the three: the right eye image, the left eye image, and the mouth image. Therefore, even when an organ area is erroneously detected in the organ area detecting process, it is relatively easy to determine whether the detected organ area corresponds to a really detected facial organ image or an erroneously detected facial organ image. Accordingly, in the face area and organ area detecting processes in the printer 100 according to this embodiment, it is possible to prevent organ area detection omission from occurring, while guaranteeing that true or false results of the organ area detection are easily identified.

In this embodiment, since the number of identifiers defined by facial organ learning data OLD is smaller than the number of identifiers defined by face learning data FLD, the organ area detecting process is faster and the volume of facial organ learning data OLD is reduced.

In order to identify an organ area really corresponding to a facial organ image from a detected organ area, a reliability of the organ area can be used. The reliability of the organ area is an index representing a certainty that an image area detected as corresponding to a facial organ image by the area detecting unit 210 is an image area really corresponding to a facial organ image. Among detected organ areas, an organ area having the highest reliability of the organ area is decided as the organ area really corresponding to the facial organ image.

As the reliability of the organ area, a value obtained by dividing the number of overlapped windows by the number of maximum overlapped windows can be used, for example. Here, the number of overlapped windows is the number of the determination target image area JIA referred when the organ area is set, that is, the number of the windows SW defining the determination target image area JIA. In addition, the number of maximum overlapped windows is the number of windows SW obtained when at least some of all the windows SW arranged on the face area FA are overlapped with the average window AW in the organ area detecting process. The number of maximum overlapped windows is uniquely determined in accordance with a movement pitch or a size change pitch of the window SW. When the detected organ area is an image area really corresponding to a facial organ image, there is a high probability that it is determined that the determination target image area JIA is an image area corresponding to a facial organ image for the plurality of windows SW having similar locations and sizes. Alternatively, when a detected organ area is not an image area corresponding to a facial organ image, but is an erroneously detected organ area, there is a high probability that it is determined that the determination target image area JIA is not an image area corresponding to a facial organ image for other windows SW having locations and sizes similar to those of the certain window SW, even when it is determined that the determination target image area JIA is an image area corresponding to a facial organ image for a certain window SW. Therefore, the value obtained by dividing the number of overlapped windows by the number of maximum overlapped windows can be used as the reliability of the organ area. Alternatively, the value of the evaluation value v may be used as the reliability of the organ area.

In order to identify an organ area really corresponding to a facial organ image from a detected organ area, a location relation between the detected organ area and the face area, or a location relation between a plurality of detected organ areas, may be used.

### B. MODIFIED EXAMPLES

The invention is not limited to the above-described examples or embodiments, and may be modified in various formed without departing from the scope of the invention. For example, the following modification can be made.

### B1. Modified Example 1

In the above-described embodiment, the determination (Step S44) of whether the T weak identifiers are selected is executed in the process (see FIG. 8) of setting the organ learning data. However, instead of this determination, a determination of whether the identifiers achieve a predetermined performance may be executed, like the determination in the process (see FIG. 3) of setting the face learning data. In this case, as the predetermined performance, a performance condition (for example, a detection error ratio of 50% or less) lower than a condition (1% or less) of the detection error ratio in the process of setting the face learning data is set. Even in this case, the number of weak identifiers forming the identifier becomes smaller consequently. The facial organ learning data OLD is set such that the organ detection omission ratio of all identifiers defined by facial organ learning data OLD is smaller than the face detection omission ratio of all identifiers defined by face learning data FLD.

### B2. Modified Example 2

In the above-described embodiment, the unit movement distance (see Step S590) of the window SW in the organ area detecting process (see FIG. 15) may be smaller than the unit movement distance (see Step S390) of the window SW in the face area detecting process (see FIG. 11). In this case, when the detected organ area is an image area really corresponding to a facial organ image and is not an image area really corresponding to an organ image, a difference easily occurs in the reliability (which is the value obtained by dividing the number of overlapped windows by the number of maximum overlapped windows) of the organ area. Accordingly, an organ area really corresponding to a facial organ image is more easily identified.

### B3. Modified Example 3

In the above-described embodiment, one identifier formed by the plurality of weak identifiers is used, when a face area and an organ area are detected by use of face learning data FLD and facial organ learning data OLD. However, an identifier having a configuration in which a plurality of strong identifiers are connected in a cascade manner may be used.

### B4. Modified Example 4

In the above-described embodiment, the face (or organ) detection omission ratio or the face (or organ) detection error ratio serving as a reference at the time of setting the threshold value th of each filter or deciding the number of filters forming the identifier is just an example. These values may be arbitrarily set.

### B5. Modified Example 5

The face area detecting process (see FIG. 11) and the organ area detecting process (see FIG. 15) according to the above-described embodiment are just examples. The invention may be modified in various forms. For example, face detecting image FDImg (see FIG. 12) is not limited to a size of 320 pixels×240 pixels, and may have other sizes. The original image OImg may be used as the face detecting image FDImg. In addition, the size, movement direction, and movement distance (movement pitch) of the window SW to be used are not limited to the above descriptions. In the above-described embodiment, the size of the face detecting image FDImg is fixed, and a window SW having one of a plurality of sizes is arranged on the face detecting image FDImg to set the determination target image area JIA having the plurality of sizes. However, face detecting images FDImg having a plurality of sizes may be generated, and a window SW having a fixed size may be arranged on the face detecting image FDImg to set a determination target image area JIA having a plurality of sizes.

In the above-described embodiment, twelve specific face inclinations are set at every 30 degrees. However, specific face inclinations more or less than twelve specific face inclinations may be set. In addition, specific face inclinations are not necessarily set, but face determination may be executed for the face inclination of 0 degrees. In the above-described embodiment, the face sample image group contains images obtained by scaling the basic face sample image FIo or rotating the basic face sample image FIo, but the face sample image group does not necessarily contain these images.

In the above-described embodiment, when it is determined that the determination target image area JIA defined by the window SW having a certain size is an image area corresponding to a face image (or a facial organ image) by the face determination (or organ determination), a window SW having a size smaller by a predetermined ratio may be arranged out of the determination target image area JIA that has been determined as the image area corresponding to the face image. In this way, process speed is improved.

In the above-described embodiment, image data stored in the memory card MC is set as the original image data, but the original image data is not limited to image data stored in the memory card MC. For example, the original image data may be image data acquired through a network.

In the above-described embodiment, the right eye, the left eye, and the mouth are set as the facial organs, and the right eye area EA(r), the left eye area EA(l), and the mouth area MA are detected as the organ areas. However, any organ of the face may be set as the facial organ. For example, one or two of the right eye, left eye, and mouth may be set as the facial organs. In addition to the right and left eyes and the mouth as the facial organs or instead of at least one thereof, an organ (for example, a noise or eyebrows) other than a face may be set, and areas corresponding to images of these organs may be detected as the organ areas.

In the above-described embodiment, the face area FA and the organ area have a rectangular shape, but the face area FA and the organ area may have a shape other than a rectangle.

In the above-described embodiment, image processing in the printer 100 serving as an image processing apparatus has been described. However, all or part of the image processing may be executed by other image processing apparatuses, such as a personal computer, a digital still camera, and a digital video camera. In addition, the printer 100 is not limited to an ink jet printer, and other types of printers such as a laser printer and a dye sublimation printer may be used.

In the above-described embodiment, parts of constituent elements implemented by hardware may be substituted for software. In contrast, some constituent elements implemented by software may be substituted for hardware.

When some or the whole of the functions of the invention are implemented by software, the software (computer program) may be provided in a computer readable recording medium. A “computer readable recording medium” is not limited to a portable recording medium, such as a flexible disk or a CD-ROM, and includes various internal storage devices such as RAM or ROM provided in a computer and external storage devices such as a hard disk fixed to the computer.

What is claimed is:

1. An image processing apparatus comprising:
a face area detecting unit that detects a face area corresponding to a face image in a target image; and
an organ area detecting unit that detects an organ area corresponding to a facial organ image in the face area,
wherein an organ detection omission ratio, which is a probability that the organ area detecting unit does not detects the facial organ image as the organ area, is smaller than a face detection omission ratio, which is a probability that the face area detecting unit does not detect the face image as the face area.

2. The image processing apparatus according to claim 1, wherein
the organ detection omission ratio is a ratio of a number of organ sample images not detected as the organ area to a number of organ sample images, when an organ area detecting process is executed on a first sample image group having at least one organ sample image that contains the facial organ image and at least one non-organ sample image that does not contain the facial organ image, and
the face detection omission ratio is a ratio of a number of face sample images not detected as the face area to a number of face sample images, when a face area detecting process is executed on a second sample image group having at least one face sample image containing the face image and at least one non-face sample image that does not contain the face image.

3. The image processing apparatus according to claim 2, wherein
the face area detecting unit executes the face area detecting process by evaluating a certainty that an arbitrary image area in the target image is an image area corresponding to the face image, using face evaluation data generated by use of the second sample image group, and
the organ area detecting unit executes the organ area detecting process by evaluating a certainty that an arbitrary image area in the face area is an image area corresponding to the facial organ image, using organ evaluation data generated by use of the first sample image group.

4. The image processing apparatus according to claim 3, wherein
the face evaluation data is generated by learning by use of the second sample image group, and
the organ evaluation data is generated by learning by use of the first sample image group and a learning condition different from that of the learning for generating the face evaluation data.

5. The image processing apparatus according to claim 3, wherein
the face evaluation data has a plurality of face identifiers connected in series and identifying whether the image area corresponds to the face image on the basis of an evaluation value representing the certainty that the image area corresponds to the face image,
the organ evaluation data has a plurality of organ identifiers connected in series and identifying whether the image area corresponds to the facial organ image on the basis of an evaluation value representing the certainty that the image area corresponds to the facial organ image, and
the number of organ identifiers is smaller than the number of face identifiers.

6. The image processing apparatus according to claim 1, wherein an organ detection error ratio, which is a probability that the organ area detecting unit detects an image which is not the facial organ image as the organ area, is larger than a face detection error ratio, which is a probability that the face area detecting unit detects an image which is not the face image as the face area.

7. The image processing apparatus according to claim 6, wherein
the organ detection error ratio is a ratio of the number of non-organ sample images detected as the organ area to the number of non-organ sample images, when the organ area detecting process is executed on the first sample image group having at least one organ sample image that contains the facial organ image and at least one non-organ sample image that does not contain the facial organ image, and
the face detection error ratio is a ratio of the number of non-face sample images detected as the face area to the number of non-face sample images, when the face area detecting process is executed on the second sample image group having at least one face sample image containing the face image and at least one non-face sample image that does not contain the face image.

8. The image processing apparatus according to claim 1, wherein the face organ is at least one of a right eye, a left eye, and a mouth.

9. An image processing method comprising:
detecting a face area corresponding to a face image in a target image; and
detecting an organ area corresponding to a facial organ image in the face area,
wherein an organ detection omission ratio, which is a probability that the facial organ image is not detected as the organ area in the detecting of the organ area, is smaller than a face detection omission ratio, which is a probability that the face image is not detected as the face area in the detecting of the face area.

10. An image processing computer program embodied in a computer readable medium and causing a computer to execute:
a face area detecting function of detecting a face area corresponding to a face image in a target image; and
an organ area detecting function of detecting an organ area corresponding to a facial organ image in the face area,
wherein an organ detection omission ratio, which is a probability that the facial organ image is not detected as the organ area in the organ area detecting function, is smaller than a face detection omission ratio, which is a probability that the face image is not detected as the face area in the face area detecting function.
